(19) United States
(12) Patent Application Publication
(10) Pub. No.: US 2026/0179371 A1
(43) Pub. Date: Jun. 25, 2026

(54) EXPRESSION GENERATING DEVICE, EXPRESSION GENERATING METHOD AND EXPRESSION GENERATING PROGRAM

(71) Applicant: NTT, Inc., Tokyo (JP)

(72) Inventors: Shinya SHIMIZU, Musashino-shi, Tokyo (JP); Airi OTA, Musashino-shi, Tokyo (JP); Ai NAKANE, Musashino-shi, Tokyo (JP); Takao NAKAMURA, Musashino-shi, Tokyo (JP)

(73) Assignee: NTT, Inc., Tokyo (JP)

(21) Appl. No.: 19/124,293

(22) PCT Filed: Nov. 10, 2022
(86) PCT No.: PCT/JP2022/041936

§ 371 Date: Apr. 25, 2025

(51) Int. Cl. G06V 10/82; G06N 20/00

(52) U.S. Cl. CPC G06V 10/82; G06N 20/00

(57) ABSTRACT

An expression generation device includes a memory and processing circuitry configured to acquire, as processing targets, a face feature related to a face image of a person and a brainwave of the person, estimate an expression feature of the acquired brainwave by using a first model obtained by performing learning on a relationship between a brainwave and an expression feature related to an expression image, which is an image representing an expression, and generate a face image with an expression by using the face feature and the estimated expression feature.

### TECHNICAL FIELD

The present invention relates to an expression generation device, an expression generation method, and an expression generation program.

### BACKGROUND ART

In the related art, a technique of performing emotion transmission using a brainwave is known. For example, a communication support technique using a brain machine interface (BMI) has been developed (refer to Non Patent Literature 1). In addition, a technique of supporting emotion transmission by analyzing a brainwave and displaying emotion states in geometric figures has been disclosed (refer to Non Patent Literature 2).

### CITATION LIST

### Non Patent Literature

Non Patent Literature 1: Ryohei HASEGAWA, “Development of a cognitive BMI “neurocommunicator” as a communication aid of patients with severe motor deficits”, Clinical Neurology, 2013, Vol. 53, No. 11 pp. 1402-1404
Non Patent Literature 2: N. Semertzidis, et al., “Neo-Noumena”, CHI EA '20: Extended Abstracts of the 2020 CHI Conference on Human Factors in Computing Systems, pp. 1-4

### SUMMARY OF INVENTION

### Technical Problem

However, according to the technique in the related art, natural communication using a brainwave may be difficult. For example, since BMI is a command input format that takes a time for input, it is difficult to timely perform emotion transmission. In addition, unconscious emotion expression cannot be transmitted. In addition, in the technique using geometric figures, it is necessary to read and understand information indicated by the geometric figure by special training. Further, understanding emotions requires directing one's gaze to geometric figures, and as a result, natural communication is difficult.

The present invention has been made in view of the above, and an object of the present invention is to perform natural communication using a brainwave.

### Solution to Problem

In order to solve the above-mentioned problems and to achieve the object, according to the present invention, there is provided an expression generation device including: an acquisition unit configured to acquire, as processing targets, a face feature related to a face image of a person and a brainwave of the person; an estimation unit configured to estimate an expression feature of the acquired brainwave by using a first model obtained by performing learning on a relationship between a brainwave and an expression feature related to an expression image, which is an image representing an expression; and a generation unit configured to generate a face image with an expression by using the face feature and the estimated expression feature.

### Advantageous Effects of Invention

According to the present invention, natural communication using a brainwave can be easily performed.

### BRIEF DESCRIPTION OF DRAWINGS

FIG. 1 is a diagram for explaining an outline of an expression generation device according to the present embodiment.

FIG. 2 is a schematic diagram illustrating a schematic configuration of the expression generation device according to the present embodiment.

FIG. 3 is a flowchart illustrating an expression generation processing procedure.

FIG. 4 is a diagram illustrating an example of a computer that executes an expression generation program.

### DESCRIPTION OF EMBODIMENTS

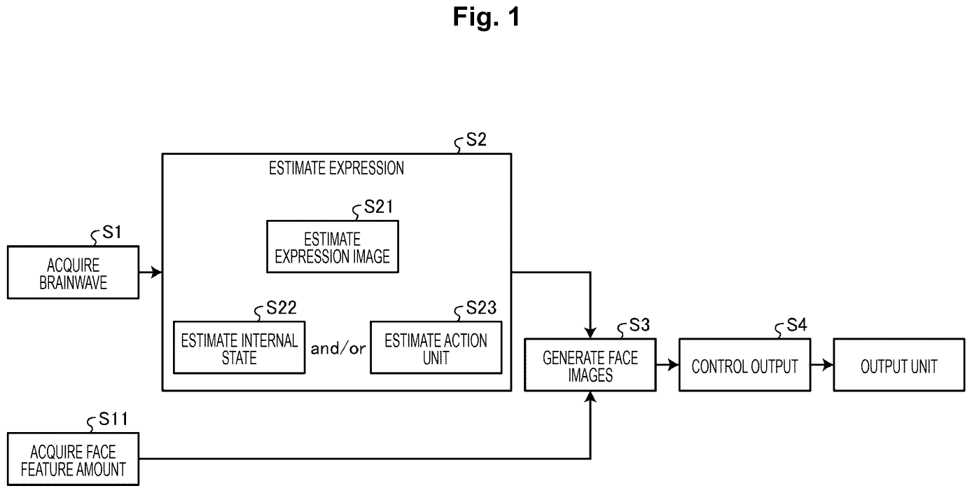

Hereinafter, an embodiment of the present invention will be described in detail with reference to the drawings. Note that the present invention is not limited by the embodiment. Further, in the description of the drawings, the same portions are denoted by the same reference numerals.

[Outline of Expression Generation Device] FIG. 1 is a diagram for explaining an outline of an expression generation device according to the present embodiment. As illustrated in FIG. 1, the expression generation device acquires a brainwave (S1), and estimates an expression feature related to an expression image (S21). Specifically, the expression generation device estimates an expression feature from the acquired brainwave by using a brainwave-to-expression-image model obtained by performing learning on a relationship between a brainwave and an expression feature related to an expression image. Note that the brainwave-to-expression-image model may be a model that directly estimates an expression feature from the brainwave, or may be a model that estimates language information (a word or a sentence) representing an expression such as “smile” or “frown expression” from the brainwave and estimates an expression feature by using the language information.

The expression generation device may estimate an internal-state feature related to an emotion state (internal state) from the acquired brainwave (S22). In this case, the expression generation device estimates an internal-state feature from the acquired brainwave, by using the brainwave-to-internal-state model obtained by performing learning on a relationship between a brainwave and an internal-state feature in a specific internal state. Further, the expression generation device estimates an expression feature from the estimated internal-state feature, by using the internal-state-to-expression model obtained by performing learning on a relationship between the internal-state feature in the specific internal state and the expression feature related to the expression image. Note that the internal-state-to-expression model may be a model that directly estimates an expression feature from the internal state, or may be a model that estimates language information (a word or a sentence) representing an internal state or an expression such as “happy (expression)” or “enduring pain (expression)” from the internal state and estimates an expression feature by using the language information.

Further, the expression generation device may estimate, from the acquired brainwave, an action-unit feature corresponding to movements of facial muscles (action units) when expressing the expression (S23). In this case, the expression generation device estimates an action-unit feature from the acquired brainwave, by using a brainwave-to-action-unit model obtained by performing learning on a relationship between a brainwave and an action-unit feature corresponding to a specific expression. In addition, the expression generation device converts the action-unit feature into an expression feature.

In addition, the expression generation device generates a face image with an expression by using the estimated expression feature and a face feature (S11) of a base face image (S3), and presents the generated face image to the user by outputting the generated face image to an output unit (S4).

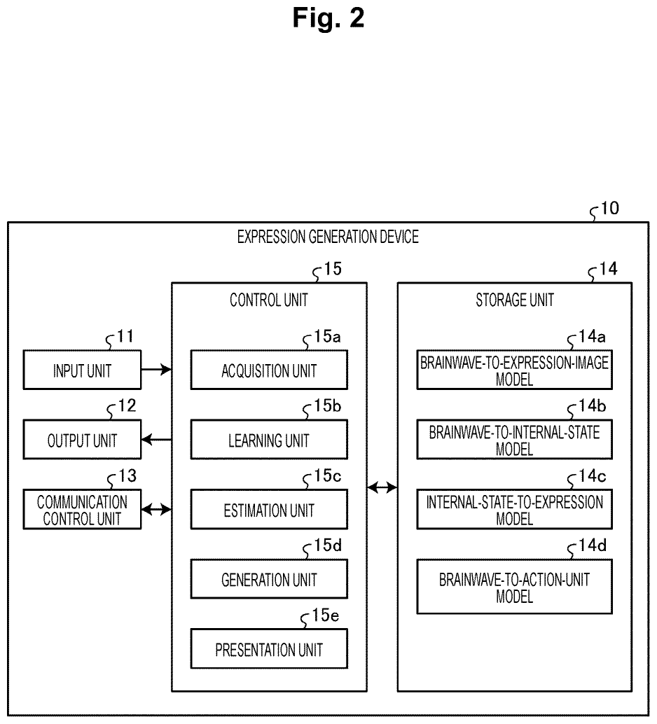

In this way, the expression generation device generates a face image with an expression based on information related to an expression operation extracted from the brainwave. Thereby, it is possible to perform emotion transmission in a natural and timely manner.

[Configuration of Expression Generation Device] FIG. 2 is a schematic diagram illustrating a schematic configuration of the expression generation device according to the present embodiment. As illustrated in FIG. 2, the expression generation device 10 according to the embodiment is implemented by a general-purpose computer such as a personal computer, and includes an input unit 11, an output unit 12, a communication control unit 13, a storage unit 14, and a control unit 15.

The input unit 11 is implemented using an input device such as a keyboard or a mouse, and inputs various types of instruction information, such as an instruction to cause the control unit 15 to start processing, in response to an input operation of an operator. The output unit 12 is implemented with a display device such as a liquid crystal display, a printing device such as a printer, or the like. For example, the output unit 12 displays a face image with an expression that is generated by expression generation processing to be described later.

The communication control unit 13 is implemented by a network interface card (NIC) or the like, and controls communication between the control unit 15 and an external device via a telecommunication line such as a local area network (LAN) or the Internet. For example, the communication control unit 13 controls communication between the control unit 15 and a management device or the like that manages various types of information.

The storage unit 14 is implemented by a semiconductor memory element such as random access memory (RAM) or flash memory, or a storage device such as a hard disk or an optical disc. In the storage unit 14, a processing program for operating the expression generation device 10, data to be used during execution of the processing program, and the like are stored in advance, or are temporarily stored each time processing is performed. Note that the storage unit 14 may be configured to communicate with the control unit 15 via the communication control unit 13.

In the present embodiment, the storage unit 14 stores a brainwave-to-expression-image model 14a, a brainwave-to-internal-state model 14b, an internal-state-to-expression model 14c, a brainwave-to-action-unit model 14d, and the like, which are to be used for expression generation processing to be described later.

The control unit 15 is implemented by a central processing unit (CPU) or the like, and executes a processing program stored in a memory. Thereby, as illustrated in FIG. 2, the control unit 15 functions as an acquisition unit 15a, a learning unit 15b, an estimation unit 15c, a generation unit 15d, and a presentation unit 15e, and executes expression generation processing. Note that each or some of these functional units may be implemented in different sets of hardware. For example, the learning unit 15b may be implemented in hardware different from other functional units. In addition, the control unit 15 may also include other functional units.

The acquisition unit 15a acquires, as processing targets, a face feature related to a face image of a person and a brainwave of the person. For example, the acquisition unit 15a acquires, as processing targets, a face feature of a base face image of a person and a brainwave of the person, via the input unit 11 or the communication control unit 13.

The brainwave acquired here may be brainwave time-series data, may be brainwave time-series data obtained by performing preprocessing such as noise removal, or may be data obtained by converting the brainwave time-series data into a brainwave feature such as a power spectrum density or an instantaneous phase.

In addition, the acquisition unit 15a may acquire a face image and convert the face image into a feature, or may use a value obtained by directly or indirectly operating the face feature.

In addition, the acquisition unit 15a may store the acquired face feature and the acquired brainwave in the storage unit 14, or may transmit the acquired face feature and the acquired brainwave to the following functional units without storing in the storage unit 14.

The learning unit 15b performs learning on a brainwave-to-expression-image model (a first model) 14a representing a relationship between a brainwave and an expression feature related to an expression image, which is an image representing an expression. Specifically, the learning unit 15b records at least one of brainwaves in various expressions, brainwaves when persons look at various expressions, or brainwaves when persons imagine various expressions, and specifies an expression feature in which an expression image representing each of these expressions is represented as a feature. In addition, the learning unit 15b performs learning on the brainwave-to-expression-image model 14a that estimates an expression feature from the brainwave by using the expression feature on the brainwave as a training label.

In this way, by recognizing brain activities when persons look at or imagine the expression by recognizing activities of mirror neurons, it is possible to construct a model that generates an unconscious/conscious expression.

Note that the brainwave-to-expression-image model 14a may be a model that directly estimates an expression feature from the brainwave, or may be a model that estimates language information (a word or a sentence) representing an expression such as “smile” or “frown expression” from the brainwave and estimates an expression feature by using the language information.

Further, the learning unit 15b performs learning on a brainwave-to-internal-state model (a second model) 14b and an internal-state-to-expression model (a third model) 14c, the brainwave-to-internal-state model 14b being a model representing a relationship between a brainwave and an internal-state feature related to an internal state representing an emotion state, the internal-state-to-expression model 14c being a model representing a relationship between an internal-state feature related to an internal state and an expression feature related to an expression image in the internal state.

Specifically, the learning unit 15b records an expression image, which represents an expression in a case where an internal state of a specific emotion is induced, and a brainwave when the specific emotion is induced, and specifies an internal-state feature in which an internal state is represented as a feature. In addition, the learning unit 15b performs learning on the brainwave-to-internal-state model 14b that estimates an internal-state feature from the brainwave by using the internal-state feature on the brainwave as a training label.

Further, the learning unit 15b specifies an expression feature in which the expression image in the induced internal state is represented as a feature. In addition, the learning unit 15b performs learning on the internal-state-to-expression model 14c that estimates an expression feature from the internal-state feature by using the expression feature with respect to the internal-state feature as a training label.

Note that the internal-state-to-expression model 14c may be a model that directly estimates an expression feature from the internal state, or may be a model that estimates language information (a word or a sentence) representing an internal state or an expression such as “happy (expression)” or “enduring pain (expression)” from the internal state and estimates an expression feature by using the language information.

In this way, in a case of estimating language information expressing an expression, in order to associate the language information with the expression image, a connecting text and images (CLIP) space obtained by performing learning such that a language feature and an image feature are represented in the same feature space is used. Thereby, the feature of the expression image can be obtained from the estimation result of the language information, and the feature can be used as the expression feature.

Further, the learning unit 15b performs learning on a brainwave-to-action-unit model (a fourth model) 14d representing a relationship between a brainwave and an action-unit feature related to an action unit representing movements of facial muscles when expressing the expression. Specifically, the learning unit 15b records an expression image when a specific expression is induced and a brainwave when the specific expression is induced, estimates an action unit by encoding the expression image according to a facial action coding system (FACS), and specifies an action-unit feature in which the action unit is represented as a feature.

Here, the action unit refers to movements of facial muscles when an expression is encoded according to FACS. Further, as a method of inducing a specific expression, for example, there are methods such as a method of intentionally making a person have a specific expression, a method of making a person look at a specific expression, a method of making a person imagine a specific expression, a method of applying some kind of stimulus to naturally make a person have an expression, and the like.

The learning unit 15b performs learning on the brainwave-to-action-unit model 14d that estimates an action-unit feature from the brainwave by using the action-unit feature on the brainwave as a training label.

The learning unit 15b may simultaneously perform learning on the brainwave-to-expression-image model 14a, learning on the brainwave-to-internal-state model 14b, and learning on the brainwave-to-action-unit model 14d.

The estimation unit 15c estimates an expression feature of the acquired brainwave by using the brainwave-to-expression-image model (the first model) 14a obtained by performing learning on a relationship between the brainwave and the expression feature related to the expression image, which is an image representing an expression.

The estimation unit 15c may further estimate an internal-state feature of the acquired brainwave by using the brainwave-to-internal-state model (the second model) 14b obtained by performing learning on a relationship between a brainwave and an internal-state feature related to an internal state representing an emotion state. In this case, the estimation unit 15c estimates an expression feature of the acquired brainwave by using the internal-state-to-expression model (the third model) 14c obtained by performing learning on a relationship between an internal-state feature related to an internal state and an expression feature related to an expression image in the internal state.

Further, the estimation unit 15c may further estimate an action-unit feature of the acquired brainwave by using the brainwave-to-action-unit model (the fourth model) 14d obtained by performing learning on a relationship between a brainwave and an action-unit feature related to an action unit representing movements of facial muscles when expressing the expression. In this case, the estimation unit 15c estimates an expression feature based on the estimated action-unit feature. For example, the action-unit feature may be directly used as an expression feature, or the action-unit feature may be converted into an expression feature by a predetermined method.

The generation unit 15d generates a face image with an expression by using the face feature and the estimated expression feature. Specifically, the generation unit 15d generates a face image with an expression by inputting the acquired face feature and the estimated expression feature to an image generation decoder. Here, as the image generation decoder, a model that is trained in advance to generate an image from the latent space is used.

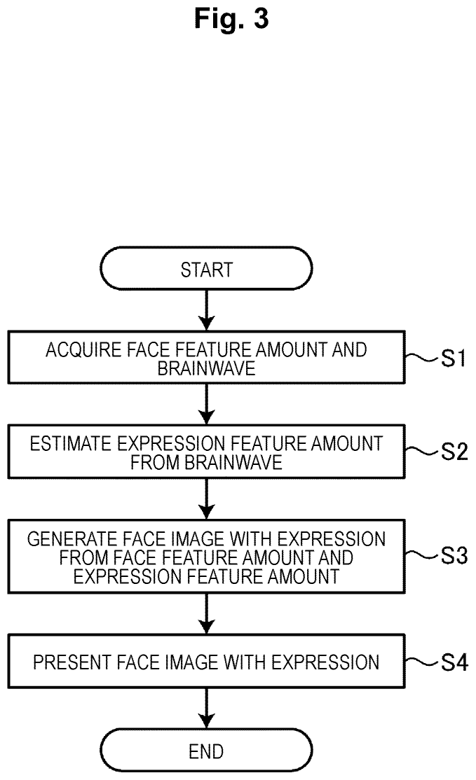

The presentation unit 15e presents the generated face image with an expression to the user via the output unit 12. Thereby, the face image with a natural expression that is generated from the brainwave is presented to the user in a timely manner.

[Expression Generation Processing] Next, expression generation processing by the expression generation device 10 according to the present embodiment will be described with reference to FIG. 3. FIG. 3 is a flowchart illustrating an expression generation processing procedure. The flowchart of FIG. 3 is started at, for example, a timing when the user performs an operation input to instruct a start.

First, the acquisition unit 15a acquires, as processing targets, a face feature related to a face image of a person and a brainwave of the person (step S1). For example, the acquisition unit 15a acquires, as processing targets, a face feature of a base face image of a person and a brainwave of the person, via the input unit 11 or the communication control unit 13.

Next, the estimation unit 15c estimates an expression feature of the acquired brainwave by using the brainwave-to-expression-image model 14a obtained by performing learning on a relationship between the brainwave and the expression feature related to the expression image, which is an image representing an expression (step S2).

The estimation unit 15c may estimate an internal-state feature of the acquired brainwave by using the brainwave-to-internal-state model 14b obtained by performing learning on a relationship between a brainwave and an internal-state feature related to an internal state representing an emotion state. In this case, the estimation unit 15c estimates an expression feature of the acquired brainwave by using the internal-state-to-expression model 14c obtained by performing learning on a relationship between an internal-state feature related to an internal state and an expression feature related to an expression image in the internal state.

Further, the estimation unit 15c may estimate an action-unit feature of the acquired brainwave by using the brainwave-to-action-unit model 14d obtained by performing learning on a relationship between a brainwave and an action-unit feature related to an action unit representing movements of facial muscles when expressing the expression. In this case, the estimation unit 15c estimates an expression feature based on the estimated action-unit feature. For example, the action-unit feature may be directly used as an expression feature, or the action-unit feature may be converted into an expression feature by a predetermined method.

In addition, the generation unit 15d generates a face image with an expression by using the face feature and the estimated expression feature (step S3). Specifically, the generation unit 15d generates a face image with an expression by inputting the acquired face feature and the estimated expression feature to an image generation decoder.

Further, the presentation unit 15e presents the generated face image with an expression to the user via the output unit 12 (step S4). Thereby, a series of expression generation processing is ended.

[Effects] As described above, in the expression generation device 10 according to the present embodiment, the acquisition unit 15a acquires, as processing targets, a face feature related to a face image of a person and a brainwave of the person. The estimation unit 15c estimates an expression feature of the acquired brainwave by using the brainwave-to-expression-image model 14a obtained by performing learning on a relationship between the brainwave and the expression feature related to the expression image, which is an image representing an expression. The generation unit 15d generates a face image with an expression by using the face feature and the estimated expression feature.

Thereby, it is possible to perform emotion transmission in a timely manner by using the face image with a natural expression that is generated from the brainwave. Therefore, natural communication using a brainwave can be easily performed. In addition, it is possible to generate a face image with an expression without using an expression image of the corresponding person, and it is also possible to communicate with a person who is difficult to create an expression such as an ALS patient.

Further, the learning unit 15b performs learning on the brainwave-to-expression-image model 14a. Thereby, it is possible to accurately estimate an expression feature from the brainwave.

In addition, the estimation unit 15c further estimates an internal-state feature of the acquired brainwave by using the brainwave-to-internal-state model 14b obtained by performing learning on a relationship between a brainwave and an internal-state feature related to an internal state representing an emotion state. In this case, the estimation unit 15c estimates an expression feature of the acquired brainwave by using the internal-state-to-expression model 14c obtained by performing learning on a relationship between an internal-state feature related to an internal state and an expression feature related to an expression image in the internal state. Thereby, it is possible to estimate an emotion corresponding to the expression, and thus it is possible to recognize a rough expression as a constraint condition. Therefore, it is possible to more stably generate a face image with an expression from the brainwave.

In this case, the learning unit 15b performs learning on the brainwave-to-internal-state model 14b and the internal-state-to-expression model 14c. As described above, by using the relevance between the emotion and the expression, even in a case where the brainwave used for learning cannot be recorded in association with the expression, it is possible to estimate an expression feature from the brainwave.

Further, the estimation unit 15c further estimates an action-unit feature of the acquired brainwave by using the brainwave-to-action-unit model 14d obtained by performing learning on a relationship between a brainwave and an action-unit feature related to an action unit representing movements of facial muscles when expressing the expression. In this case, the estimation unit 15c estimates an expression feature based on the estimated action-unit feature. Thereby, it is possible to estimate movements of facial muscles from the brainwave, and thus it is possible to generate a face image with a fine expression.

In this case, the learning unit 15b performs learning on the brainwave-to-action-unit model 14d. Thereby, it is possible to more accurately estimate an expression feature from the brainwave.

[Program] It is also possible to create a program in which the processing executed by the expression generation device 10 according to the embodiment is described in a computer executable language. As an embodiment, the expression generation device 10 can be implemented by installing an expression generation program for executing the expression generation processing as package software or online software in a desired computer. For example, an information processing device can be caused to function as the expression generation device 10 by causing the information processing device to execute the expression generation program. The information processing device described here includes a desktop personal computer or a laptop personal computer. In addition, the category of the information processing device includes a mobile communication terminal such as a smartphone, a mobile phone, or a personal handyphone system (PHS), a slate terminal such as a personal digital assistant (PDA), and the like. In addition, the function of the expression generation device 10 may be implemented in a cloud server.

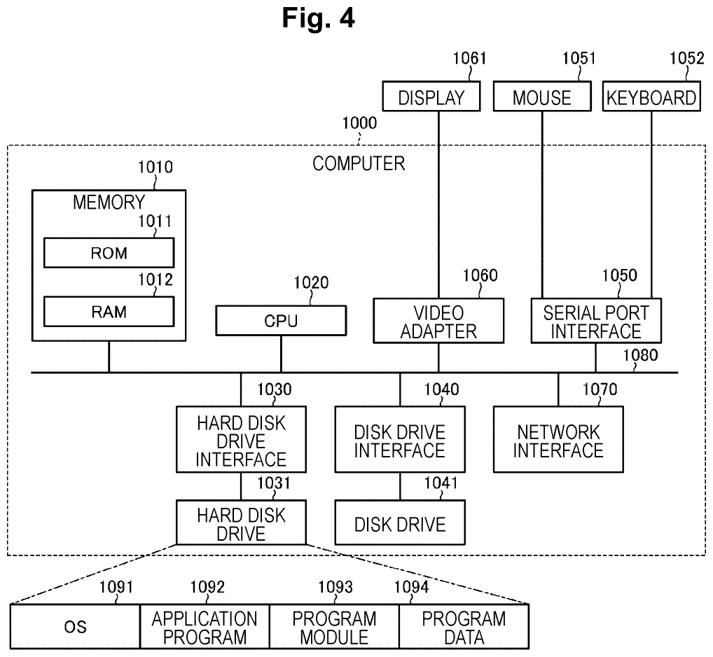

FIG. 4 is a diagram illustrating an example of a computer that executes an expression generation program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disk is inserted into the disk drive 1041. The serial port interface 1050 is connected to, for example, a mouse 1051 and a keyboard 1052. The video adapter 1060 is connected to, for example, a display 1061.

Here, the hard disk drive 1031 stores, for example, an OS 1091, an application program 1092, a program module 1093, and program data 1094. All pieces of the information described in the embodiment are stored, for example, in the hard disk drive 1031 or the memory 1010.

In addition, the expression generation program is stored, for example, in the hard disk drive 1031 as a program module 1093 in which commands to be executed by the computer 1000 are described. Specifically, the program module 1093 in which the processing executed by the expression generation device 10 described in the embodiment is described is stored in the hard disk drive 1031.

Further, data used for information processing by the expression generation program is stored as the program data 1094, for example, in the hard disk drive 1031. Then, the CPU 1020 reads, into the RAM 1012, the program module 1093 and the program data 1094 stored in the hard disk drive 1031 as necessary and executes each procedure described above.

Note that the program module 1093 and the program data 1094 related to the expression generation program are not limited to being stored in the hard disk drive 1031, and may be stored in, for example, a removable storage medium and read by the CPU 1020 via a disk drive 1041 or the like. Alternatively, the program module 1093 and the program data 1094 related to the expression generation program may be stored in another computer connected via a network such as LAN or a wide area network (WAN), and may be read by the CPU 1020 via the network interface 1070.

Although the embodiment to which the present invention made by the present inventors is applied has been described above, the present invention is not limited by the description and the drawings constituting a part of the disclosure of the present invention according to the present embodiment. That is, other embodiments, examples, operation techniques, and the like made by those skilled in the art based on the present embodiment are all included in the scope of the present invention.

### REFERENCE SIGNS LIST

10 Expression generation device
11 Input unit
12 Output unit
13 Communication control unit
14 Storage unit
14a Brainwave-to-expression-image model (first model)
14b Brainwave-to-internal-state model (second model)
14c Internal-state-to-expression model (third model)
14d Brainwave-to-action-unit model (fourth model)
15 Control unit
15a Acquisition unit
15b Learning unit
15c Estimation unit
15d Generation unit
15e Presentation unit

1. An expression generation device comprising:
a memory; and
processing circuitry configured to:
acquire, as processing targets, a face feature related to a face image of a person and a brainwave of the person;
estimate an expression feature of the acquired brainwave by using a first model obtained by performing learning on a relationship between a brainwave and an expression feature related to an expression image, which is an image representing an expression; and
generate a face image with an expression by using the face feature and the estimated expression feature.

2. The expression generation device according to claim 1, wherein the processing circuitry is further configured to perform learning on the first model.

3. The expression generation device according to claim 1, wherein the processing circuitry is further configured to estimate an internal-state feature of the acquired brainwave by using a second model obtained by performing learning on a relationship between a brainwave and an internal-state feature related to an internal state representing an emotion state, and estimate an expression feature of the acquired brainwave by using a third model obtained by performing learning on a relationship between an internal-state feature related to an internal state and an expression feature related to an expression image in the internal state.

4. The expression generation device according to claim 3, wherein the processing circuitry is further configured to perform learning on the second model and the third model.

5. The expression generation device according to claim 1, wherein the processing circuitry is further configured to estimate an action-unit feature of the acquired brainwave by using a fourth model obtained by performing learning on a relationship between a brainwave and an action-unit feature related to an action unit representing movements of facial muscles when expressing the expression, and estimate an expression feature based on the estimated action-unit feature.

6. The expression generation device according to claim 5, wherein the processing circuitry is further configured to perform learning on the fourth model.

7. An expression generation method executed by an expression generation device, the expression generation method comprising:
acquiring, as processing targets, a face feature related to a face image of a person and a brainwave of the person;
estimating an expression feature of the acquired brainwave by using a first model obtained by performing learning on a relationship between a brainwave and an expression feature related to an expression image, which is an image representing an expression; and
generating a face image with an expression by using the face feature and the estimated expression feature.

8. A non-transitory computer-readable recording medium storing therein an expression generation program that causes a computer to execute a process comprising:
acquiring, as processing targets, a face feature related to a face image of a person and a brainwave of the person;
estimating an expression feature of the acquired brainwave by using a first model obtained by performing learning on a relationship between a brainwave and an expression feature related to an expression image, which is an image representing an expression; and
generating a face image with an expression by using the face feature and the estimated expression feature.
